(19) United States
(12) Patent Application Publication
(10) Pub. No.: US 2019/0376530 A1
(43) Pub. Date: Dec. 12, 2019

(54) MOTOR SUPPORT FOR MOTOR VEHICLE BLOWER

(71) Applicant: Valeo Systemes Thermiques, Le Mesnil-Saint-Denis Cedex (FR)

(72) Inventors: Cyril Gontier, Le Mesnil Saint-Denis (FR); Samuel Escobedo, Le Mesnil Saint-Denis (FR); Emmanuel Rudloff, Le Mesnil Saint-Denis (FR)

(73) Assignee: Valeo Systemes Thermiques, Le Mesnil-Saint-Denis Cedex (FR)

(21) Appl. No.: 16/480,050

(22) PCT Filed: Jan. 16, 2018
(86) PCT No.: PCT/FR2018/050107

§ 371 Date: Jul. 23, 2019

(30) Foreign Application Priority Data
Jan. 23, 2017 (FR) 1750511

(51) Int. Cl. F04D 29/66; B60H 1/00; F04D 25/08; F04D 29/42

(52) U.S. Cl. CPC F04D 29/668; F04D 29/4206; F04D 25/08; B60H 1/00471

(57) ABSTRACT

The subject of the invention is a motor support for a blower of a motor vehicle heating, ventilation and/or air-conditioning system, comprising a first ring (3), referred to as an outer ring, and a second ring (4), referred to as an inner ring, positioned inside the outer ring, the inner ring being configured to house an electric motor, and the outer ring being configured to be fixed to part of the motor vehicle heating, ventilation and/or air-conditioning system, said inner ring comprising an axial retention device (12) for the retention of said motor and at least one end stop (13) able to collaborate with an associated bearing surface (14) of the outer ring (3).

The invention relates to a motor support for an air blower intended to be mounted on a motor vehicle heating, ventilating and/or air conditioning system.

Such a motor support generally comprises a first ring, called outer ring, configured to be fixed to a part of the heating, ventilating and/or air conditioning system of the motor vehicle, such as a blower housing of the system.

The motor support also comprises a second ring, called inner ring, coaxial with the outer ring, and configured to house an electric motor. Said electric motor particularly comprises a drive shaft on which a fan wheel, for example of centrifugal type, can be mounted.

It is known that the motor support also comprises a third ring in order to hold the motor in position in the air blower.

However such an arrangement is complex and costly to manufacture.

The aim of the invention is to at least partially overcome this disadvantage.

To this end, the subject matter of the invention is a motor support for an air blower of a motor vehicle heating, ventilating and/or air conditioning system, comprising a first ring, called outer ring, and a second ring, called inner ring, and placed inside said first ring, the inner ring being configured to house an electric motor, said to be axial direction, and the outer ring being configured to be fixed to a part of the heating, ventilating and/or air conditioning system of the motor vehicle, said inner ring comprising an axial retention device for said motor and at least one stop that can engage an associated bearing area of the outer ring.

Thus, the motor support according to the present invention allows the motor to be held by the inner ring alone, which allows the third ring to be removed.

According to another characteristic of the invention, the inner ring comprises a plurality of stops, called a central stop and end stops, and the outer ring comprises a plurality of bearing areas, each of said stops being able to engage at least one of said bearing areas.

According to another characteristic of the invention, the central stop forms an obtuse angle with each end stop.

According to another characteristic of the invention, at least one stop of the inner ring comprises a wall facing the bearing area of the outer ring and spaced from the bearing area by a distance of between 1 mm and 5 mm, and preferably by a distance of 2 mm.

According to another characteristic of the invention, the inner ring comprises stiffening ribs.

According to another characteristic of the invention, the inner ring comprises two diametrically opposite motor balancing windows.

According to another characteristic of the invention, the axial retention device comprises a plurality of axial retention components, each axial retention component projecting axially out from a main body of the inner ring from a base as far as a head, at least one of the stops comprising an end at least partially facing said base of one of the axial retention components.

According to another characteristic of the invention, the motor support comprises at least one vibration decoupling block placed between the inner ring and the outer ring.

According to another characteristic of the invention, the outer ring comprises a damping finger having an at least partially spherical end that can engage said at least one vibration decoupling block.

According to another feature of the invention, the inner and outer rings are coaxial.

Another subject matter of the invention is an air blower for a motor vehicle heating, ventilating and/or air conditioning system, comprising a motor support as described above, an electric motor housed in the inner ring, and a protective cover for the motor and for the motor support.

Another subject matter of the invention is a heating, ventilating and/or air conditioning system for a motor vehicle, comprising an air blower as described above, and a blower housing, the outer ring of the motor support being rigidly connected to the blower housing.

Other characteristics and advantages of the invention will appear furthermore upon reading the following description. This description is purely illustrative and must be read with reference to the appended drawings in which:

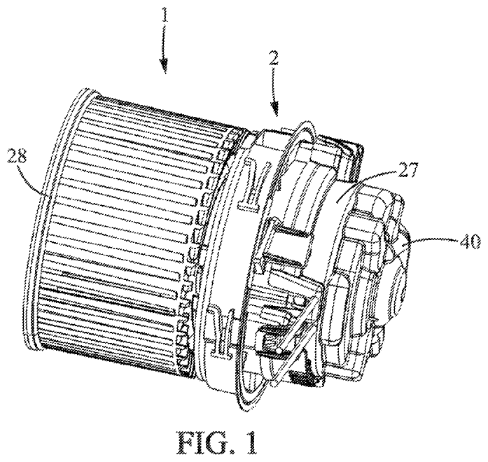

FIG. 1 illustrates a perspective view of an air blower according to the present invention, after assembly;

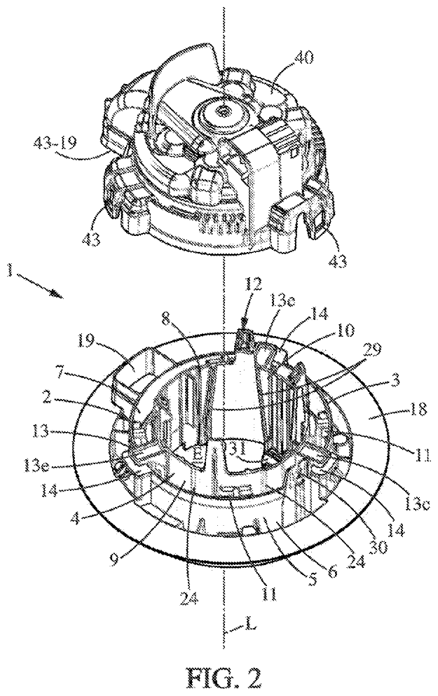

FIG. 2 illustrates a perspective view of the blower of FIG. 1, partially assembled:

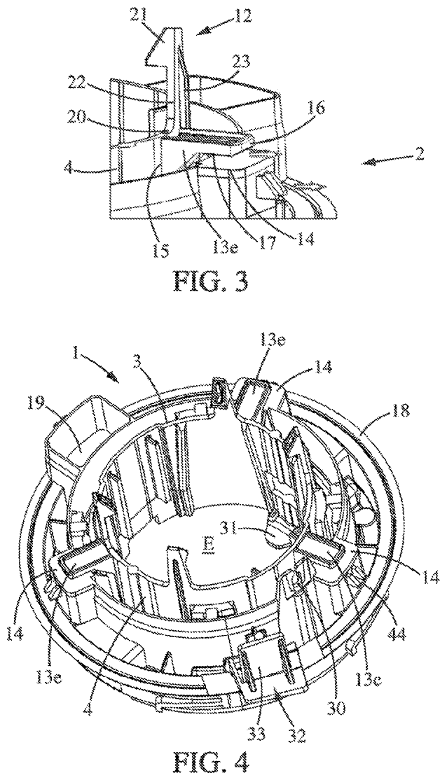

FIG. 3 illustrates a perspective view of a detail of the blower of FIG. 1;

FIG. 4 illustrates a perspective view of an air blower according to an alternative embodiment of the invention; and

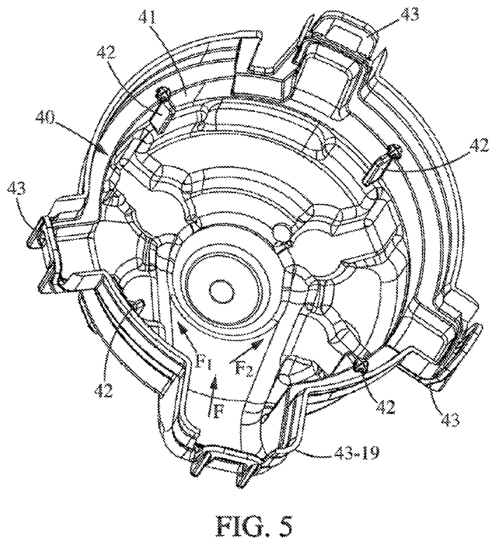

FIG. 5 illustrates a perspective view of an interior of a protective cover for the motor.

### Blower

The subject matter of the invention is a motor support, referenced as 1 in the figures.

As can be seen in FIGS. 1 to 3, the motor support 1 comprises a first ring, called outer ring, referenced as FIG. 3.

The motor support 1 also comprises a second ring, called inner ring, referenced as 4.

The outer 3 and inner 4 rings are described in detail at a later time.

Another subject matter of the invention is the blower 2 comprising the motor support 1.

The blower 2 comprises a motor (not illustrated) housed in the inner ring.

The motor is held by retention components of the motor support, which are described in detail at a later time.

The blower 2 also comprises a protective cover for the motor and for the motor support 40, described in detail with reference to FIG. 5.

As can be seen in the figures, the blower 2 comprises a collar 18 coaxial with the inner 4 and outer 3 rings, and rigidly connected to the outer ring 3.

The collar 18 allows the blower to be fixed to a part of a heating, ventilating and/or air conditioning system for a motor vehicle, such as a blower housing, not shown.

An opening 19, illustrated in FIG. 2, is intended to form a cooling air duct for the motor.

### Motor Support

As already indicated, the motor support 1 comprises the outer ring 3 and the inner ring 4.

The outer ring 3 has a substantially cylindrical shape delimiting an inner space E.

The outer ring 3 is configured to be fixed to a part of the heating, ventilating and/or air conditioning system of the motor vehicle, such as a blower housing, not illustrated.

The inner ring 4 is placed in the inner space E while being coaxial with the outer ring 3.

The inner ring 4 is configured to house the electric motor, for example a brushed DC electric motor supplied with a drive shaft (not illustrated) extending in the direction of coaxiality of the rings 3 and 4, called axial direction, L.

The outer ring 3 comprises a main body 5 that is substantially cylindrical.

The main body 5 is a wall delimited by an outer side 6 and an inner side 7.

The inner ring 4 comprises a substantially cylindrical main body 8.

The main body 8 is delimited by an outer wall 9 and an inner wall 10.

The inner side 7 of the outer ring 3 faces the outer wall 9 of the inner ring 4.

The motor support 1 also comprises at least one vibration decoupling block 11 placed between the inner ring 4 and the outer ring 3.

In the illustrated embodiment, the motor support 1 comprises four vibration decoupling blocks 11.

Each vibration decoupling block 11 bears on the inner wall 7 of the outer ring 3 and on the outer wall 9 of the inner ring 4.

Each vibration decoupling block 11 is generally H-shaped.

Each vibration decoupling block 11 is preferably made from elastomeric material.

The vibration decoupling blocks 11 make it possible to prevent the vibrations generated by the electric motor from being transmitted to the outer ring 3 of the motor support 1, and, consequently, to the heating, ventilating and/or air conditioning system of the motor vehicle.

As can be particularly seen in FIGS. 2 and 3, the inner ring 4 comprises an axial retention device for the motor, referenced as 12.

The inner ring 4 also comprises at least one stop 13.

The outer ring 3 comprises at least one bearing area 14 associated with said at least one stop 13.

In the illustrated embodiment, the inner ring comprises three stops 13, a central stop 13c next to two end stops 13e on either side.

Each stop 13 projects radially out from the main body 8 of the inner ring 4 in a direction where it approaches the outer ring 3.

One 15 of the ends of each stop 13 is rigidly connected to the main body 8 whereas the other end 16 is free.

The free end 16 has a planar surface 17 placed facing the associated bearing area 14 of the outer ring 3.

Each bearing area 14 projects radially out from the main body 5 of the outer ring 3 in a direction where it moves away from the inner ring 4.

Each stop 13 helps to block the motor in the case of the motor vehicle jolting, the stop 13 absorbing vibrations by displacement of the free end 16 thereof; and, for stronger vibrations, the free end 16 of each stop 13 comes to bear against the associated bearing area 14 of the outer ring 3.

Each stop 13 helps to block the motor in the case of the motor vehicle jolting. These jolts cause displacements of the inner ring 4 that are greater than during normal operation. Thus, the free end 16 of each stop 13 comes to bear against the associated bearing area 14 of the outer ring 3.

Each stop 13 also ensures that the H-shaped blocks are not too stressed during the vehicle life.

The distance between the planar surface of each stop 13 and the associated bearing area 14 is between 1 mm and 5 mm, and preferably approximately 2 mm.

Beyond this value, the H-shaped blocks will lack endurance.

As can be seen in the figures, the axial retention device 12 comprises four axial retention components 12, also called retaining clips.

Each retaining clip is generally hook-shaped.

Each axial retention component 12 projects axially out from the main body 8 of the inner ring 4 from a base 20 as far as a chamfered head 21.

The chamfered head 21 is intended to hold the motor.

Each retention component 12 has a longitudinal wall 22 supplied with a stiffening longitudinal rib 23 from the base 20 as far as the head 21.

The chamfered head 21 is preferably hollow, such as to facilitate the process of preparation of the motor support 1.

Preferably, at least one of the stops 13 is placed at least partially facing the base 20 of one of the axial retention components 12.

In the illustrated embodiment, the two end stops 13e are placed partially facing the base 20 of one of the axial retention components 12.

Thus, the end 15 of these stops 13 that is rigidly connected to the main body 8 of the inner ring 4 extends from the stiffening ring 23 in a direction where it moves away from the retaining clip 12.

As can be seen in the figures, the outer wall 9 of the inner ring 4 comprises stiffening axial ribs 24.

As also becomes clear from the figures, the inner ring 4 comprises two diametrically opposite motor balancing windows.

Advantageously, the inner wall 10 of the inner ring 4 is supplied with motor radial clamping ribs 29.

The radial clamping ribs 29 are preferably inclined with respect to the longitudinal direction L in order to prevent any leave during the stripping of the process of preparation.

As can be seen in FIG. 2, the motor support 1 comprises a hole 30 for passage of a cable for powering and/or controlling the motor.

As can be seen in FIG. 2, the motor support 1 also comprises one or more components 31 for holding the motor.

Each holding component 31 has a general rounded triangular planar shape.

Each holding component 31 extends into the space E mainly in a plane orthogonal to the axis L.

Preferably, the motor support 1 comprises two diametrically opposite holding components 31.

In the alternative illustrated in FIG. 4, the motor support 1 comprises a brace 32 for holding the blower a motor vehicle heating, ventilating and/or air conditioning system.

The brace 32 comprises two walls 33 spaced apart from one another, such as to form a lodging for receiving a wall or a projection placed on a motor vehicle heating, ventilating and/or air conditioning system housing.

### Protective Cover

As are more particularly visible in FIGS. 2 and 5, the protective cover 40 comprises an inner wall 41 that can cover the motor and the inner 4 and outer 3 rings of the motor support 1.

As can be seen in FIG. 5, the inner wall 41 comprises a plurality of toes for holding the motor, which are referenced as 42.

In the illustrated embodiment, the inner wall 41 comprises four holding toes 42.

The protective cover comprises a plurality (four in FIG. 5) of projecting components 43.

Each projecting component 43 is configured to engage pilots 44 of the motor support, such that the pilots 44 click into the projecting components 43.

As becomes clear from FIG. 5, one of the components 43, denoted 43-19, is intended to cover the opening 19.

As can be seen in FIG. 5, the cover 40 makes it possible to guide an airflow F into two airflows F1 and F2.

The circulation of the air according to the two flows F1 and F2 provides better cooling of the motor.

### Processes of Preparation of the Motor Support

The inner ring 4 and the outer ring 3 are produced by molding.

According to a first process of preparation, an embossed mold has the impression for the two rings.

A first step consists in closing the mold. Then, slides are inserted (to allow the subsequent stripping of the free ends of the stops), before injecting the material into the mold.

Next, the slides are removed, and then the motor support 1 is stripped out by opening the mold.

According to another mode of preparation, a mold with two different cavities is used, one of the molds having the impression for the inner ring 4 and the other mold having the impression for the outer ring 3, and this makes it possible to do without the use of a slide for stripping out the free ends of the stops 13.

In this case, the outer ring 3 and the inner ring 4 are molded independently, a rotary mold making it possible to place the inner ring in the outer ring thanks to the rotary movement of the mold and a molding operation for rigidly connecting the rings is carried out.

### Advantages

As already indicated, a single part, namely the inner ring 4, provides all of the motor holding functions, and this makes it possible to not complicate the structure of the motor support, simplifies the processes of preparation and reduces the costs thereof.

Moreover, since the stops also provide a vibration decoupling function, they help to increase the life of the elastomeric material blocks and to reduce the transmission of the vibrations toward the interior of the motor vehicle.

Of course, the invention is not limited to the illustrated embodiment.

It is completely conceivable for the inner ring to comprise ribs intended to engage elastomeric decoupling means, which is for example parallelepipedal, which are supplied with openings, such that the ribs of the inner ring can be inserted into the openings.

It is noted that a decoupling additional component, such as a membrane, fills the space between the inner ring and the outer ring.

1. A motor support for an air blower of a motor vehicle heating, ventilating and/or air conditioning system, comprising:
a first outer ring; and
a second inner ring placed inside said first ring,
the inner ring being configured to house an electric motor, and the outer ring being configured to be fixed to a part of the heating, ventilating and/or air conditioning system of the motor vehicle, said inner ring comprising an axial retention device for said motor and at least one stop that can engage an associated bearing area of the outer ring.

2. The motor support as claimed in claim 1, wherein the inner ring comprises a plurality of stops, and the outer ring comprises a plurality of bearing areas, each of said stops being able to engage at least one of said bearing areas.

3. The motor support as claimed in claim 1, wherein at least one stop of the inner ring comprises a wall facing the bearing area of the outer ring and spaced from the bearing area by a distance of between 1 mm and 5 mm.

4. The motor support as claimed in claim 1, wherein the inner ring comprises stiffening ribs.

5. The motor support as claimed in claim 1, wherein the inner ring comprises two diametrically opposite motor balancing windows.

6. The motor support as claimed in claim 1, wherein the axial retention device comprises a plurality of axial retention components, each axial retention component projecting axially out from a main body of the inner ring from a base as far as a head, at least one of the stops comprising an end at least partially facing said base of one of the axial retention components.

7. The motor support as claimed in claim 1, comprising at least one vibration decoupling block placed between the inner ring and the outer ring.

8. The motor support as claimed in claim 7, wherein the outer ring comprises at least one damping finger having an at least partially spherical end that can engage said at least one vibration decoupling block.

9. The motor support as claimed in claim 1, wherein the inner and outer rings are coaxial.

10. An air blower for a motor vehicle heating, ventilating and/or air conditioning system, comprising:
a motor support having a first outer ring and a second inner ring placed inside said first ring,
the inner ring being configured to house an electric motor, and the outer ring being configured to be fixed to a part of the heating, ventilating and/or air conditioning system of the motor vehicle, said inner ring comprising an axial retention device for said motor and at least one stop that can engage an associated bearing area of the outer ring
an electric motor housed in the inner ring; and
a protective cover for the motor and for the motor support.
